(19) United States
(12) Patent Application Publication
(10) Pub. No.: US 2006/0091691 A1
(43) Pub. Date: May 4, 2006

(54) Vehicle windshield visor

(76) Inventors: Steve Drabant, Snellville, GA (US); W. Shawn Kozak, Decatur, GA (US)

Correspondence Address: MERCHANT & GOULD PC, P.O. BOX 2903, MINNEAPOLIS, MN, 55402-0903, US

(21) Appl. No.: 10/976,187

(22) Filed: Oct. 28, 2004

(51) Int. Cl. B60J 1/20

(52) U.S. Cl. 296/95.1

(57) ABSTRACT

An exterior windshield visor for motor vehicles, a method for manufacturing a windshield visor, a motor vehicle having a windshield visor, and a method for attaching a windshield visor to a motor vehicle are provided according the invention. The visor includes a double walled construction that defines a cavity therein. The visor is sufficiently rigid to prevent unacceptable levels of visor flutter due to wind forces and can be manufactured efficiently without the need to use a large amount of raw material and/or expensive manufacturing steps. In addition, the visor according to the invention can be securely attached to a wide variety of different vehicles with little or no modification.

### FIELD OF THE INVENTION

The present invention relates to an exterior windshield visor for a motor vehicle, a method for manufacturing a windshield visor, a motor vehicle having a windshield visor, and a method for attaching a windshield visor to a motor vehicle.

### BACKGROUND OF THE INVENTION

Visors are fairly common and are described, for example, in U.S. Pat. No. 6,099,065 to Lund; U.S. Pat. No. 6,099,064 to Lund; U.S. Pat. No. 5,108,142 to Lund; U.S. Pat. No. 4,966,404 to Lund; U.S. Pat. No. 4,842,320 to Kingsley; U.S. Pat. No. 4,726,619 to Haugestad; and U.S. Pat. No. 4,758,040 to Kingsley et al. Visors including those described in the above-listed patents have been attached to vehicles to shield against sun and rain.

Visors generally project from the roof of the vehicle towards the front of the vehicle to provide shielding without decreasing the effective viewing area of the windshield. During high speed travel the air that flows across the visors can impart forces strong enough to rip poorly designed visors from the motor vehicle. In addition, differences in air pressure across the visor can cause “flutter,” which can be seen as a bending and/or twisting of the visor or heard as a buzzing or flapping noise emanating from the visor. The occurrence of flutter is not only distracting to the vehicle occupants, but it can also fatigue the visor and eventually cause it to rip off of the vehicle roof. Accordingly, the aerodynamic characteristics and the structural strength and rigidity of the visors are important consideration in the design and manufacture of windshield visors.

Prior art windshield visors, including the windshield visors listed above, are generally either single walled visors or double walled visor that are constructed by joining single wall starting materials. Though double walled visors can be relatively more rigid than single walled visors and also can exhibit other preferred aesthetic and aerodynamic qualities, they are usually more difficult and therefore expensive to manufacture. An object of the invention is to provide an improved double walled visor that is easier and less expensive to manufacture.

### SUMMARY OF THE INVENTION

The invention relates to a molded windshield visor for a vehicle. The visor includes a double walled construction that defines a cavity therein. The visor according to the invention is sufficiently rigid to prevent an unacceptable level of visor flutter even under high wind conditions, which commonly results when the vehicle that the visor is mounted thereto moves at a high rate of speed. The visor according to the invention can be manufactured via a cavity molding process in which the raw material and/or labor cost are less than in prior art methods of manufacturing double wall visors. In addition, the visor according to the invention is constructed such that it can be conveniently attached to a wide variety of different vehicles.

### BRIEF DESCRIPTION OF THE DRAWINGS

FIG. 1 is a perspective view of a windshield visor according to the principles of the present invention mounted to a vehicle;

FIG. 2 is the windshield visor of FIG. 1 in an assembly view;

FIG. 3 is a top view of the windshield visor of FIG. 1;

FIG. 4 is a front elevation view of the windshield visor of FIG. 1;

FIG. 5 is an end elevation view of the windshield visor of FIG. 1;

FIG. 6 is a cross-sectional view of the windshield visor of FIG. 3 along the line 6-6; and

FIG. 7 is a cross-sectional view of the windshield visor of FIG. 3 along the line 7-7.

### DETAILED DESCRIPTION OF THE PREFERRED EMBODIMENT

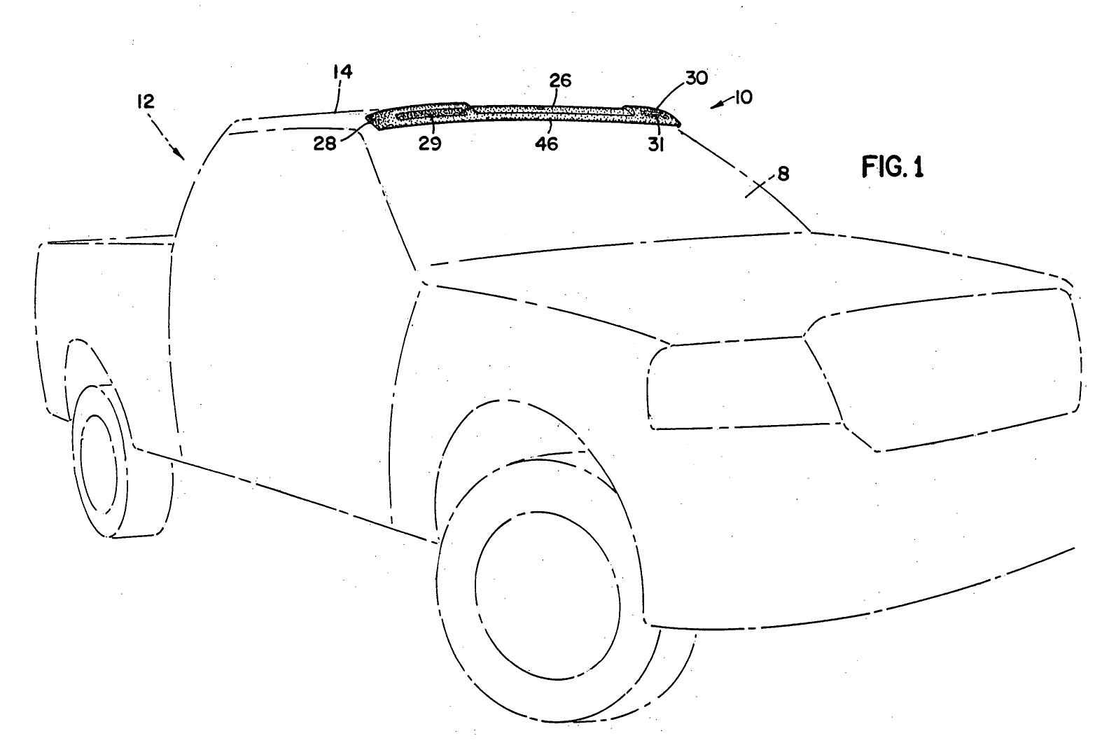

Referring to FIG. 1, a windshield visor in accordance with the present invention is depicted at reference numeral 10 mounted to a vehicle 12 projecting from the vehicle roof 14 over the windshield 8. According to the present invention, a windshield visor is a device that is attachable to a vehicle to provide some shielding of the windshield from sunlight and/or precipitation. The windshield visor 10 preferably projects over the windshield 8 as to not interfere with the effective viewing area of the windshield 8. The windshield visor 10 of the present invention may hereinafter be referred to as the visor 10.

As those skilled in the art will appreciate, the dimensions of vehicles vary widely from manufacturer to manufacturer and from model to model. Accordingly, it should be understood that although the windshield visor depicted in the figures is shown attached to a pickup truck, the visor can be adapted to fit other types of vehicles, for example, cars, boats, and other types of trucks. An exemplary way of adapting the visor to fit other vehicles would include modifying the length of the visor to match the width of wider or narrower vehicles and/or modifying the profile of the visor 10 to complement the aerodynamic or aesthetic characteristics of the various vehicles.

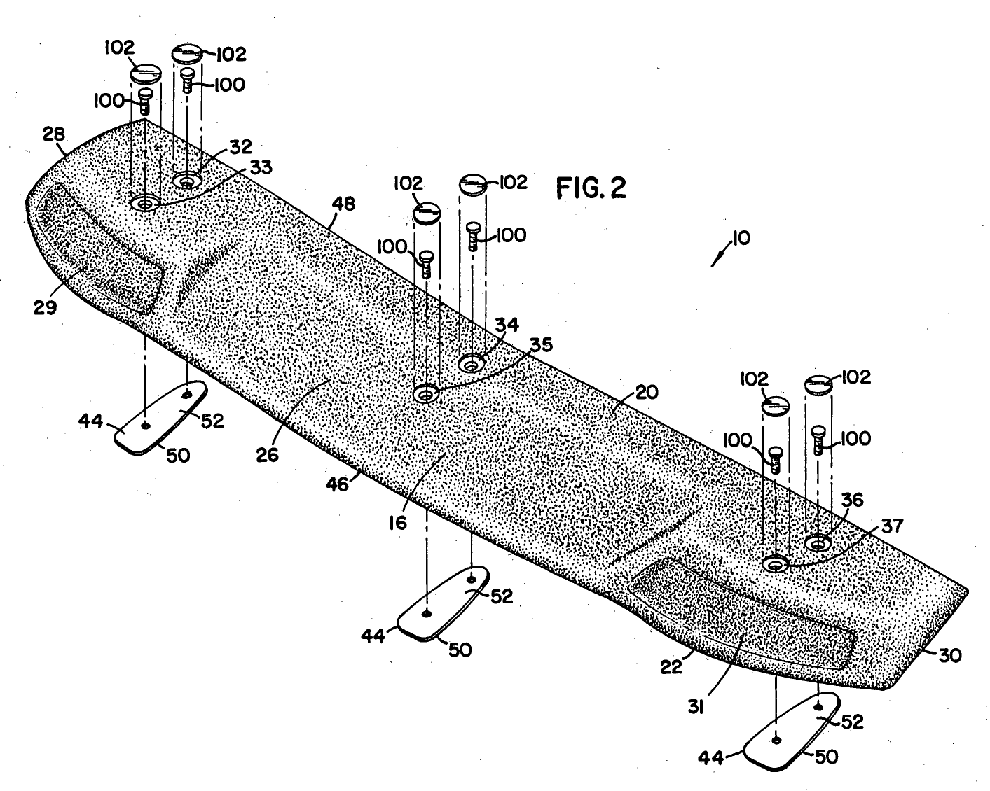

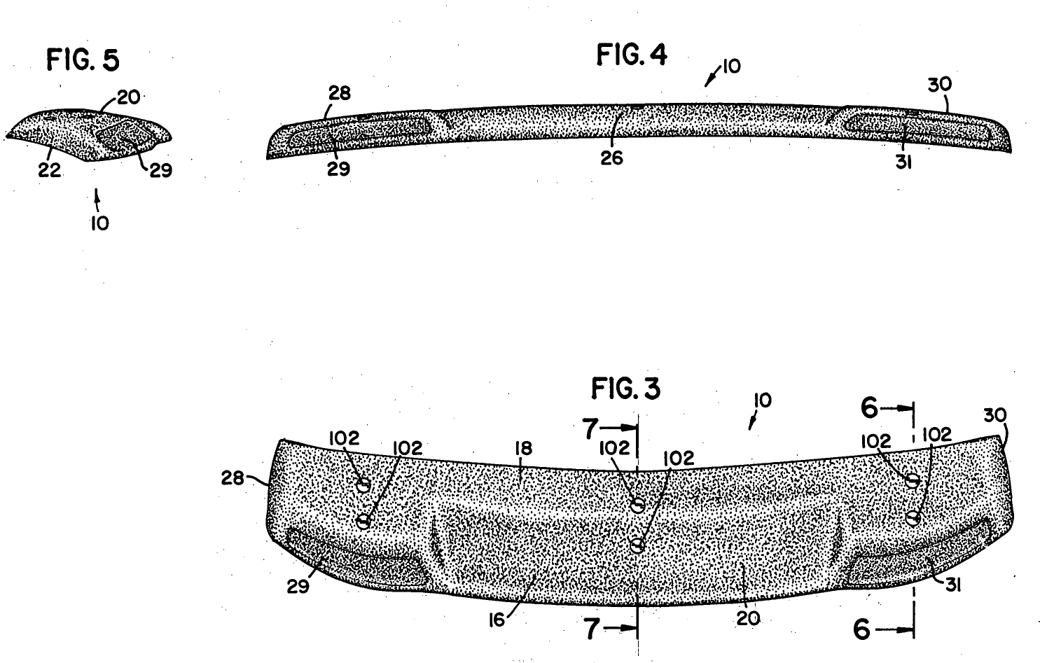

Referring to FIGS. 2-5, the visor 10 includes a shielding region 16 and an attachment region 18 (referenced in FIG. 3). When mounted on the vehicle 12 the shielding region 16 extends forward of the roof 14 and over the front windshield 8, thereby shielding a portion of the windshield 8 from sun and precipitation. The attachment region 18 extends rearward over the roof 14 and is configured to be used to secure the shielding region 16 to the vehicle 12. Both of the above-identified regions will be described in greater detail below.

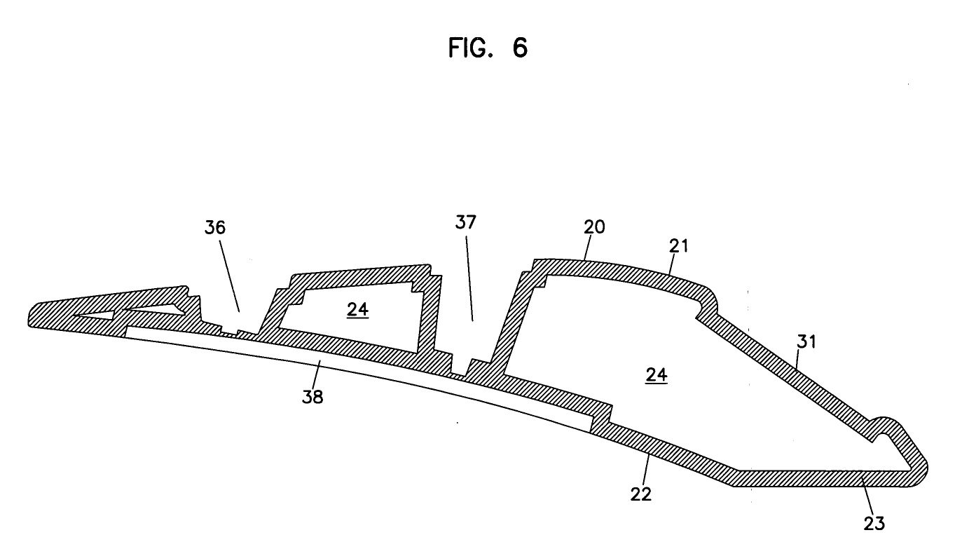

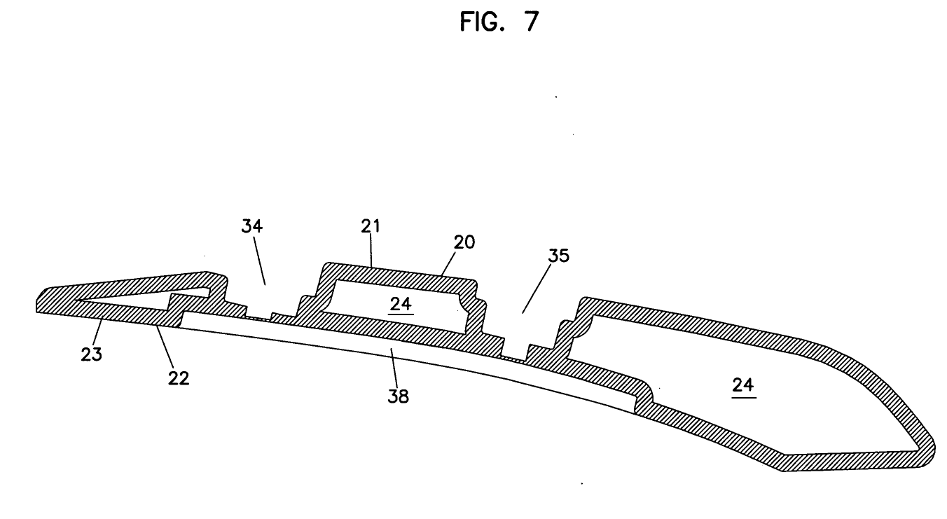

For the purposes of description, the shielding region 16 and the attachment region 18 of the visor 10 include a top surface 20 and a bottom surface 22 (referenced in FIGS. 2 and 5). When the visor 10 is installed, the top surface 20 faces away from the vehicle 12 and the bottom surface 22 faces toward the vehicle 12. In the embodiment shown in FIGS. 2-5, the top of a top wall 21 defines the top surface 20 and the bottom of a bottom wall 23 defines the bottom surface 22. The top wall 21 and the bottom wall 23 are separated by a cavity 24, shown in FIGS. 6 and 7. In the particular embodiment shown, the top wall 21 and bottom wall 23 are formed of a continuous sheet of molded polymer material. The above-described double wall construction results in a visor 10 that is structurally more rigid than a single wall visor constructed of the same amount and type of material.

In the embodiment shown, the top surface 20 of the shielding region 16 includes a scooped region 26, which is shown as a depressed or recessed area positioned between a first raised end portion 28 and a second raised end portion 30 of the visor 10. The raised end portions 28 and 30 of the shielding region 16 include recesses 29 and 31 that are sized to house auxiliary lights or other types of accents including decorative pieces. In should be understood that the top surface 20 could include different features than the features shown in the depicted embodiment, i.e., the scooped region 26 and the raised end portions 28 and 30 are optional.

In the embodiment shown, the top surface 20 of the attachment region 16 of the visor 10 includes six wells 32, 33, 34, 35, 36, and 37 otherwise referred to as countersinks that are each configured to house fasteners 100. Associated with the wells 32, 33, 34, 35, 36, and 37 are well caps 102 that are configured to be inserted into the wells after the fasteners 100 are secured. The well caps 102 are constructed to prevent debris from entering the wells 32, 33, 34, 35, 36, and 37 as well as to provide a smooth finished appearance across the top surface 20 of the visor 10. The smooth appearance provides a certain aesthetic appeal as well as utilitarian advantages that include improved airflow over the visor 10. As shown in FIGS. 6 and 7, the top wall 21 and the bottom wall 23 are joined together at the well locations. In other words, the top wall 21 and the bottom wall 23 of the visor 10 “kiss-off” in the vicinity of the wells 32, 33, 34, 35, 36, and 37. The above-described construction of a double wall visor 10 having kiss-offs around the well 32, 33, 34, 35, 36, and 37 locations results in a visor having localized regions around the fasteners that are particularly resistant to bending and breaking. Nonetheless, it should be appreciated that the visor according to the invention can include alternative features for securely engaging fasteners.

As discussed above, the bottom surface 22 of the visor 10 is molded with the top surface 20 as a single piece. As such, the bottom surface in the shielding region 16 and the attachment region 18 are shown to be continuous. In addition to providing a certain aesthetic appeal, such a profile allows air that flows up across the windshield 8 to flow underneath the visor 10 from the front edge 46 of the visor 10 to the rear edge 48 of the visor 10 without creating an unacceptable amount of wind noise. The bottom surface 22 further includes visor-mounting regions such as mounting pad receiving recesses 38 (shown in FIGS. 6 and 7), which are sized to receive mounting pads 44 that interface between the visor 10 and the vehicle 12. It should be understood that the bottom surface 22 of the visor 10 according to the invention does not need to include pad receiving recesses 38, 40, and 42, and can include various additional or alternative features. It should also be understood that though the entire visor 10 in the depicted embodiment is made of a single sheet of molded material, such a construction is not necessary. For example, certain parts of the visor 10 could be attached to other parts of the visor 10 via adhesives, fasteners, and welds.

Referring to FIG. 2, the visor 10 is shown in a perspective exploded view showing the mounting pads 44 and the fasteners 100 and the well caps 102. The pads 44 are shown as pieces of material that are sized and shaped specifically to fit the visor 10 to specific vehicles. Pads 44 are shown as pieces of rubber having a top surface 52 and a bottom surface 50. The bottom surfaces 50 can be contoured or otherwise constructed to fit with the contoured surface of the roof 14 of the vehicle 12, whereas the top surfaces 52 can be contoured or otherwise constructed to fit in the mounting pad recesses 38 of the visor 10. The mounting pads 44 at the ends of the visor 10 may be of different shape and size than the mounting pad or pads 44 at the center of the visor 10 to account for the curvature of the roof 14 of the vehicle 12. The mounting pads 44 in some embodiments include adhesive on one or both of the top surface 52 and the bottom surface 50. Though the use of three rubber mounting pads 44 is shown, it should further be appreciated that in alternative embodiments there may be more or less mounting pads 44 and they can be constructed from numerous other types of materials. Moreover, in some alternative embodiments, the visor 10 can be attached to the vehicle 12 via alternative means that do not involve the use of mounting pads 44.

Manufacturing the visor 10 can be accomplished using known blow molding techniques. The process may generally include the following steps: charging a mold with molten polymer; injecting gas into the mold to bias the molten polymer material against the inner sidewalls of the mold; and removing the visor from the mold once cured. In some embodiments the thickness of the top wall 21 and the bottom wall 23 are about 1/16 to ¼ of an inch and more preferably between ⅛ to 3/16 of an inch. It should be appreciated that other thicknesses are possible depending on the particular features of the visor 10 and materials used to mold the visor. In addition, other molding processes can be employed in the manufacture of the visor 10, for example, a rotational molding process can be used where the molten polymer is biased to the side of the mold via gravitational and centrifugal forces or twin sheet thermoforming.

Installing the visor 10 to a vehicle may include the steps of inserting the pads 44 into the pad receiving recesses 38 in the bottom surface 22 of the visor 10. Positioning the visor 10 as desired on the roof 14 of the vehicle 12 such that the shielding region 16 extends over a portion of the windshield 8. Drilling starting holes through the pads 44 and the roof 14 of the vehicle. Applying sealant to the drilled holes, and inserting a self-tapping screw through the wells 32, 33, 34, 35, 36, and 37 of the visor 10 and the pads 44 into each of the drilled holes. Applying sealant over the top of the self-tapping screws and inserting the well caps 102 into the pairs of wells 32, 34, and 36. It should be appreciated that the above steps can occur in a number of different sequences and that the above-described mounting procedure is one of many alternative mounting procedures. For example, according to some alternative embodiments the installation may not involve perforating the roof 14 of a vehicle 12. In such embodiments the mounting can involve clamping the visor 10 to a particular portion of the vehicle 12 or using adhesives to connect the visor 10 to the vehicle 12.

The above specification, examples and data provide a complete description of the manufacture and use of the composition of the invention. Since many embodiments of the invention can be made without departing from the spirit and scope of the invention, the invention resides in the claims hereinafter appended.

1. A windshield visor for mounting to an exterior of a motor vehicle, the visor comprising:
a first wall including an inner surface and an outer surface; and
a second wall including in inner surface and an outer surface, wherein the first wall and second wall are formed with a cavity therebetween from a continuous polymeric material.

2. The windshield visor according to claim 1, further comprising a visor-mounting region that includes a recess on at least one of the outer surfaces of the first or second wall of the visor.

3. The windshield visor according to claim 1, further comprising a visor-mounting region wherein at least a portion of the inner surface of the first wall and a portion of the inner surface of the second wall are molded as one piece in the visor-mounting region.

4. The windshield visor according to claim 2, wherein the recess in the visor-mounting region is configured to mate with a mounting pad contoured to engage an outer surface of a motor vehicle.

5. The windshield visor according to claim 3, wherein the visor includes three visor-mounting regions that are spaced apart by the cavity between the first wall and second wall of the visor.

6. The windshield visor according to claim 2, wherein the visor-mounting region is configured to receive a fastener.

7. The windshield visor according to claim 2, wherein the visor-mounting region includes a hole through the first wall and the second wall of the visor that does not perforate the cavity of the visor.

8. The windshield visor according to claim 2, further comprising a cap that is configured to cover the recess.

9. The windshield visor according to claim 1, wherein the cross-sectional area of the cavity between the first wall and the second wall is narrower at the center of the visor than at each end portion of the visor.

10. A method of manufacturing a windshield visor for mounting to an exterior of a motor vehicle comprising the steps of:
providing a mold cavity having molten polymer resin therein; and
biasing the molten polymer against an inner surface of the mold to form a visor having a cavity and wall thickness ranging from about 1/16 to about 5/16 of an inch.

11. The method according to claim 10, wherein the step of biasing comprises blow molding.

12. The method according to claim 10, wherein the step of biasing comprises rotational molding.

13. The method according to claim 10, wherein the step of biasing comprises twin sheet thermoforming.

14. The method according to claim 10, wherein at least a portion of the inner surface of the first wall and the inner surface of the second wall are molded together in a visor-mounting region.

15. The windshield visor according to claim 14, wherein the visor-mounting region is recessed from at least one of the top surface or the bottom surface of the visor.

16. The windshield visor according to claim 14, wherein the visor-mounting region is recessed from the top surface of the visor and the bottom surface of the visor.

17. A method of installing a windshield visor to a roof of a motor vehicle comprising the step of:
securing the visor to the vehicle with a first surface of a mounting pad positioned against the visor and a second surface of the mounting pad positioned against a roof of a vehicle, wherein the mounting pad is constructed of a deformable material so that the mounting pad conforms to a space between the vehicle and the visor.

18. The method according to claim 17, wherein a surface of the windshield visor facing the vehicle includes a recess shaped to receive an upper portion of the mounting pad.

19. The method according to claim 17, wherein the second surface of the mounting pad is contoured to engage the roof of the motor vehicle.

20. The method according to claim 17, wherein the mounting pad comprises a rubber construction.

21. The method according to claim 17, wherein the step of securing the visor to the vehicle includes the step of screwing or bolting the visor to the roof of the vehicle.

22. The method according to claim 17, wherein the step of securing the visor to the vehicle includes the step of adhering the mounting pad to the roof of the motor vehicle with adhesive.

23. A motor vehicle having a windshield visor comprising:
a motor vehicle including a windshield and a roof above the windshield;
a visor attached to the roof projecting over a portion of the windshield, wherein the visor includes:
a first wall including an inner surface and an outer surface;
a second wall including in inner surface and an outer surface, wherein the first wall and second wall are formed with a cavity therebetween from a continuous polymeric material.

24. The motor vehicle according to claim 23, wherein the visor is a cavity molded visor.

25. The motor vehicle according to claim 24, wherein the visor is a blow molded visor.

26. The motor vehicle according to claim 23, wherein the visor includes a visor-mounting region where the inner surface of the first wall and the second wall are joined.
